(19) United States
(12) Patent Application Publication
(10) Pub. No.: US 2026/0303243 A1
(43) Pub. Date: Oct. 1, 2026

(54) AUGMENTED AUDIO CONTROL

(71) Applicants: David COHEN, Herzliya (IL); Gadi GRAUS, Tel-Aviv (IL)

(72) Inventors: David COHEN, Herzliya (IL); Gadi GRAUS, Tel-Aviv (IL)

(21) Appl. No.: 19/480,856

(22) PCT Filed: May 2, 2024
(86) PCT No.: PCT/IL2024/050416

§ 371 Date: Nov. 3, 2025

Related U.S. Application Data
(60) Provisional application No. 63/463,346, filed on May 2, 2023.

(51) Int. Cl. H04H 60/43; G06F 3/16; G10L 21/034; H04H 20/95; H04H 40/36; H04S 3/00

(52) U.S. Cl. CPC H04H 60/43; G06F 3/165; G10L 21/034; H04H 20/95; H04H 40/36; H04S 3/008; H04S 2400/13

(57) ABSTRACT

Broadcast and/or receiving apparatus allows for individual control of separate sound sources in a broadcast event. The apparatus comprises inputs for a plurality of audio channels, each audio channel being related to a separate sound source. A channel identity inserter adds a channel identity signal into some or all of the audio channels, for indicating a respective separate sound source, and a controller uses the channel identity signals to control audio of the identified audio channel to allow a user to control the separate sound sources individually. In place of an inserted channel identity, a voiceprint can be used instead, and a user interface is also provided.

### RELATED APPLICATION/S

This application claims the benefit of priority of U.S. Provisional Patent Application No. 63/463,346 filed on 2 May 2023, the contents of which are incorporated herein by reference in their entirety.

### FIELD AND BACKGROUND OF THE INVENTION

The present invention, in some embodiments thereof, relates to augmented audio control, for example in broadcasts and playbacks, and, more particularly, but not exclusively, to a way of selecting between multiple speakers in such broadcasts and playbacks.

Broadcasts of live events, such as sports events or state occasions often involve a view of the event and multiple commentators giving their views. Some viewers may prefer some of the commentators over others and may wish to have favourite commentators at higher volume and less favoured commentators on lower volume or even on mute.

Now generally, the different commentators speak into different microphones and are thus on initially different voice channels. However all the voice channels are typically mixed into a single channel since the broadcast format allows for only a single voice channel.

Thus from the point where the signal is mixed for broadcast it becomes impossible to manipulate the voice channel, and it certainly is not possible for the receiving apparatus to identify the different voice channels.

The question of doing such manipulation was raised in the Quora question and answer website and the answer given was as follows:
“Simple answer: You can't. Longer answer: You can, but it would involve breaking into either the broadcast booth and removing the headsets from the broadcasters, or breaking into the audio production area and removing the audio channels coming from the broadcasters from the overall mix.

### SUMMARY OF THE INVENTION

The present embodiments provide ways for receiver equipment to distinguish between and operate on the individual voice channels that make up the mixed voice channel received in the broadcast signal.

It is to be noted herein that broadcast here simply means a signal from a single source sent to multiple destinations, irrespective of whether it is via the Internet, via hosting sites such as YouTube™, or via the airwaves, whether it is delivered live or after a delay, including on-demand to requesting users or any other manner that is from one source to many or unspecified recipients. According to an aspect of some embodiments of the present invention there is provided broadcast apparatus for controlling one or more separate sound sources in a broadcast event, the apparatus comprising:
inputs for audio channels, each audio channel being related to a one of said separate sound sources;
at least one channel identity inserter for inserting a channel identity signal into at least one of said audio channels, for indicating a respective separate sound source; and
a controller configured to use at least one of said channel identity signals to control audio of said respective audio channel to allow a user to select a desired one of said sound sources.

Embodiments may include a voice mixer, for mixing said plurality of audio channels into a combined audio channel including an indicator of which of said plurality of audio channels is dominant in said combined audio channel.

The channel identity signal and said corresponding indication of relative dominance may be an ultrasonic or a digital signal, which may be embedded into the combined audio channel. That is to say, at the point where the channels are mixed, a determination may be made as to which of the audio channels is dominant, and the channel identifier of the dominant channel may be embedded into the combined channel.

In an embodiment, one of the audio channels carries audio of the event and at two or more of the audio channels carry voice commentary on said event. The channel identity inserter may insert said channel identity signal for said audio channels comprising voice commentary, or for said background, say based on channel audio dominance.

The broadcast apparatus may introduce a delay to the event signal, say to allow for various types of processing.

According to a second aspect of the present invention there is provided receiver apparatus for receiving a broadcast signal having a combined audio channel including a plurality of constituent audio channels, some of said constituent audio channels comprising respective ultrasonic channel identities and the combined audio channel bearing an ultrasonic indicator of a currently dominant audio channel, the receiving apparatus comprising:
an input configured to allow a user to select one or more of said constituent audio channels for muting;
a detector for detecting a currently dominant audio channel in said combined audio channel, and
a volume control for changing a volume or muting at least said currently dominant audio channel in said combined audio channel. The receiver apparatus may be a receiving application appropriate for a specific kind of receiving device.

In an embodiment, said input is configured to allow a volume to be set for at least one of said constituent audio channels; the apparatus further comprising a volume control to use said set volume when said at least one of said constituent audio channels is the dominant audio channel. Thus the user may be able to set a desired volume in advance for a given speaker.

In an embodiment, muting may be achieved by injecting a 180 degree phase shift of the unwanted channel.

The receiving apparatus may introduce a delay to the broadcast signal to enable processing to take place.

The receiving apparatus may be set to mute predetermined words should they turn up in the received audio stream.

The receiving apparatus may counteract changes in volume of the broadcast.

According to a third aspect of the present invention there is provided a receiver apparatus for receiving a broadcast signal having a combined audio channel including a plurality of constituent audio channels, some of said constituent audio channels comprising respective voices, the receiving apparatus comprising:
an input configured to allow a user to select one or more of said constituent audio channels for muting;
a voiceprint identifier for identifying a voiceprint of a currently dominant voice in said channel; and
a mute control configured to mute or change the volume of said combined audio channel when said currently dominant voice is identical with a voice of said one or more constituent audio channels selected for muting.

According to a fourth aspect of the present invention there is provided an interactive display for an audio-visual event, the event having a plurality of audio channels, at least some of said audio channels being voice channels of event commentators, the display configured to provide indicators for said at least some of said audio channels, said indicators comprising respective mute controls to mute ones of said audio channels, viewers being able to control respective ones of said audio channels individually via said respective mute controls.

In embodiments, said indicators comprise interactive volume controls, said viewers being able to set volumes for ones of said audio channels including muting respective channels.

In embodiments, different channels are set differently.

According to a fifth aspect of the present invention there is provided broadcast apparatus for controlling one or more of a plurality of speakers in a broadcast event, the apparatus comprising: inputs for a plurality of audio channels;
a packet former configured to form data packets for transmission, the data packets configured to carry each of said audio channels separately and individually identifiable in said data packets, such that each audio channel is separately controllable at a receiver.

According to a sixth aspect of the present invention there is provided a broadcast method for controlling one or more of a plurality of speakers in a broadcast event, the method comprising:
receiving a plurality of audio channels;
inserting a channel identity signal into at least one of said audio channels;
multiplying respective ones of said at least one channel identity signal with audio of said respective audio channel to provide an indication of relative dominance of said respective audio channel; and
mixing said plurality of audio channels into a combined audio channel including an indicator of which of said plurality of audio channels is dominant in said combined audio channel. The channel identity signal and said corresponding indication of relative dominance may be ultrasonic or digital.

As above, one audio channels typically carries audio of the event and two or more audio channels carry voice commentary on said event. The channel identity signal may be added just for the audio channels comprising voice commentary, or for the event channel as well, as preferred. According to a seventh aspect of the present invention there is provided a receiver method for receiving a broadcast signal having a combined audio channel including multiple constituent audio channels, some of said constituent audio channels having respective ultrasonic or digital or other channel identities and the combined audio channel bearing an indicator of a currently dominant audio channel, the receiving method comprising:
allowing a user to select one or more of said constituent audio channels for controlling;
detecting a currently dominant audio channel in said combined audio channel, and
controlling at least said currently dominant audio channel in said combined audio channel.

The method may involve setting volume levels for individual audio channels; the receiver method using the set volume of the currently dominant constituent audio channel.

According to an eighth aspect of the present invention there is provided a receiver method for receiving a broadcast signal having a combined audio channel including a plurality of constituent audio channels, some of said constituent audio channels comprising respective voices, the receiving method comprising:
allowing a user to select one or more of said constituent audio channels for controlling;
identifying a voiceprint of a currently dominant voice in said channel; and
controlling said combined audio channel when said currently dominant voice is identical with a voice of said one or more constituent audio channels selected for muting.

According to a ninth aspect of the present invention there is provided an interactive display method for an audio-visual event, the event having a plurality of audio channels, at least some of said audio channels being voice channels of event commentators, the method comprising providing indicators on said display for said at least some of said audio channels, said indicators comprising respective mute controls to mute ones of said audio channels, users being able to control, set a volume or mute ones of said audio channels via said respective mute controls.

According to a tenth aspect of the present invention there is provided a broadcast method for muting one or more speakers in a broadcast event, the method comprising:
obtaining inputs from a plurality of audio channels;
forming data packets for transmission, the data packets configured to carry each of said audio channels separately and individually identifiable in said data packets, such that each audio channel is separately controllable at a receiver.

In embodiments, feedback may be provided to a broadcaster of the control decisions made at a receiving end. Thus the broadcaster may note that certain commentators are more popular than others. The broadcaster may use such feedback to determine compensation or assign credit or the like for individual commentators. It is to be noted that providing feedback is applicable to all embodiments of receiving devices herein.

Voice prints may be obtained from a pre-existing database, or may be extracted at the receiving from a sample of a voice received. Again this applies to all of the embodiments herein using voiceprints.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWING(S)

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a simplified block diagram illustrating sound channel mixing in a live event broadcast system, modified according to the present embodiments;

FIG. 2 is a variation of the embodiment of FIG. 1 in which a background sound channel is also given a channel identifier;

FIG. 3 is a broadcast receiver apparatus modified according to the present embodiments to control the voice channel according to the received sound input and originator channel identifications;

FIG. 4 is a variation of the embodiment of FIG. 3 wherein voiceprints are used to identify the sound sources;

FIG. 5 is a view of one possible user interface according to embodiments of the present invention to allow a user to apply different settings to different sound sources; and

FIG. 6 is a variation of the broadcast system of FIG. 1 for packet data broadcasting.

### DESCRIPTION OF SPECIFIC EMBODIMENTS OF THE INVENTION

The present invention, in some embodiments thereof, relates to augmented audio control, for example in broadcasts and playbacks, and, more particularly, but not exclusively, to a way of selecting between multiple speakers in such broadcasts and playbacks.

In the present embodiments, a broadcast apparatus allows for individual control of separate sound sources in a broadcast event. The apparatus comprises inputs for a plurality of audio channels, each audio channel being related to a separate sound source. A channel identity inserter adds a channel identity signal into some or all of the audio channels, for indicating a respective separate sound source, and a controller uses the channel identity signals to control audio of the identified audio channel to allow a user to control the separate sound sources individually. In place of an inserted channel identity, a voiceprint can be used instead, and a user interface is also provided.

Receiving devices may include televisions, including smart televisions, computers such as desktop and laptop computers, tablets, mobile telephones and the like, and receiving applications for use with the specific receiving devices.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

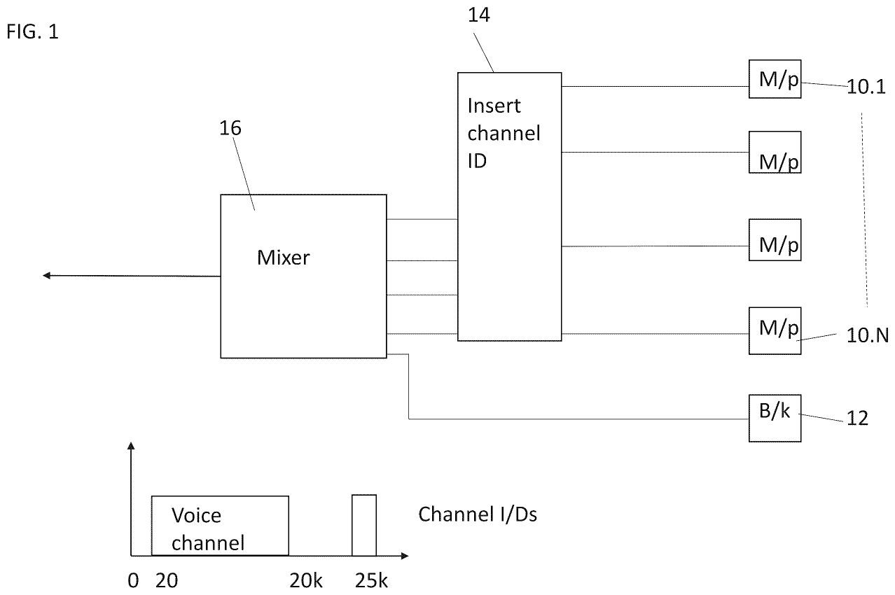

Referring now to the drawings, FIG. 1 illustrates broadcast apparatus for allowing the control at the receiving end or at least subsequent to forming the broadcast signal of separate sound sources in a broadcast signal. The issue typically arises in a live broadcast with multiple commentators, where the end user may prefer certain commentators and dislike others.

A first embodiment is shown in FIG. 1. Herein each speaker has a separate microphone M/p 10.1 . . . 10.n. A separate microphone b/k 12 captures the sound of the event itself.

The signals are supplied to block 14 which inserts into each voice channel an embedded identification—channel ID. The channel ID may be an electronically distinctive signal in the ultrasonic range so that it is not audible to the end user, say above 25 kHz—see insert. Alternatively, the embedded identification may be a digital signal. The embedded signal may identify the channel or it may identify the speaker or the type of channel.

The voice channels are then mixed together in mixer 16. The mixer 16 does not simply mix the channels but identifies one or two dominant channels and inserts the dominant channels into the mix, so that channel ID of a presently silent channel does not get recorded.

Subsequently, at the receiving end, the currently dominant channel ID can be obtained using a suitable controller, and the sound manipulated accordingly, as will be discussed in greater detail below.

The mixer 16 may thus mix the audio channels into a combined audio channel including an indicator of which channel is dominant in the combined audio channel.

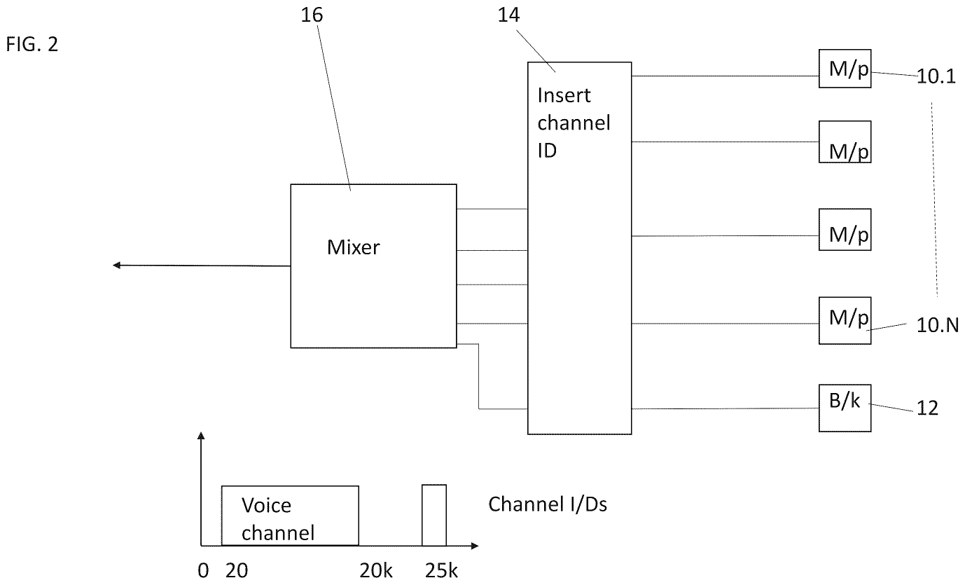

Reference is briefly made to FIG. 2, which illustrates a variation of the embodiment of FIG. 1, in which the background or event sound channel is also given a channel ID by being routed to the insert channel ID box 14.

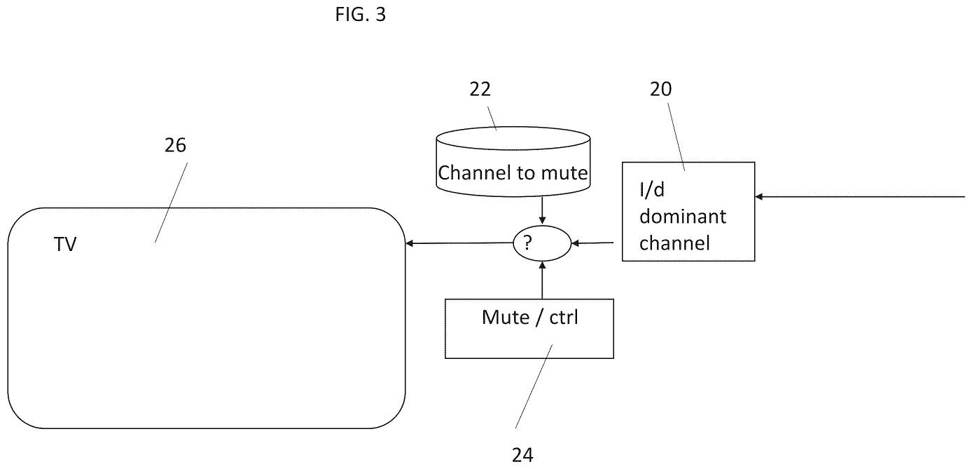

Reference is now made to FIG. 3, which illustrates a device at the receiving end for identifying and manipulating the sound part of the broadcast signal. Box 20 is able to identify the dominant channel and box 22 contains the user's instructions as to which channels to amplify, and which to suppress or mute. Box 24 compares the channels identified in boxes 20 and 22 and carries out the appropriate action, for example changing the volume or muting the sound completely.

It is noted that one of the ways of muting a channel is via self-correlation, that is by multiplying the channel with a 180 degree phase shift of itself.

A delay may be introduced into the broadcast, either at the sender or at the receiver end, in order to carry out any necessary calculations and manipulations.

The broadcast, suitably manipulated, may then be shown on the user's audio-visual apparatus 26

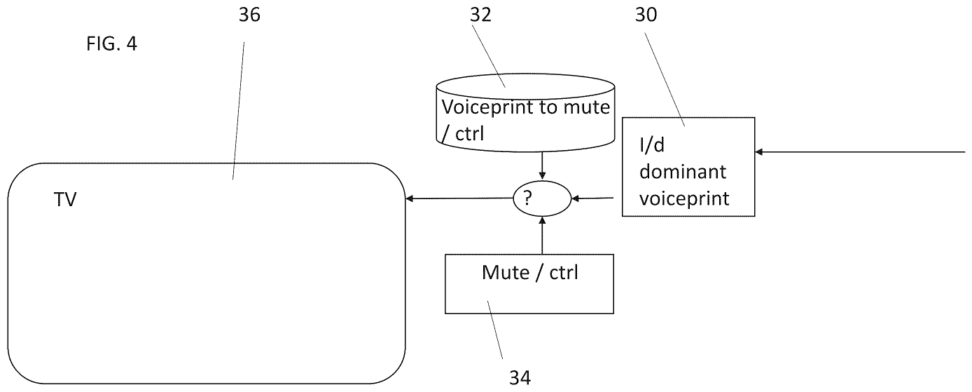

Reference is now made to FIG. 4, which is a simplified diagram illustrating a further embodiment of the present invention. In the embodiment of FIG. 4, there is no special equipment needed at the sending end and all the manipulation is carried out at the receiving end. All voices have a voiceprint, a unique signature that can identify the individual voice. The viewer is provided with, or generates by themselves, say from previous broadcasts, voiceprints of the commentators. The viewer then uses the user interface, to be discussed hereinbelow, to select the commentators that are preferred or not preferred. Box 30 identifies the currently dominant voiceprint. Box 32 contains the viewer's instructions for the different commentators, and box 34 gives the appropriate command for the currently dominant voice so that the user views the manipulated signal on audio visual apparatus 36.

In general, commentators are a fairly small group of people, so providing a database of voiceprints of known commentators may cover most instances. The viewer may be enabled to take a sample and generate a voiceprint of a not-previously known commentator, say as part of an application that enables the present embodiments, provides the interface etc.

Additionally or alternatively, the box 32 may look out for specific words that the user does not want, such as swear words. The broadcast is buffered for a second or so, and if any words specified are heard they are muted.

Likewise, it is possible to use the mute control 34 to counteract sudden increases in volume. Thus, advertisements are often broadcast at greater volume then the content, and on detecting an increase in volume, the mute control 34 may reduce the volume.

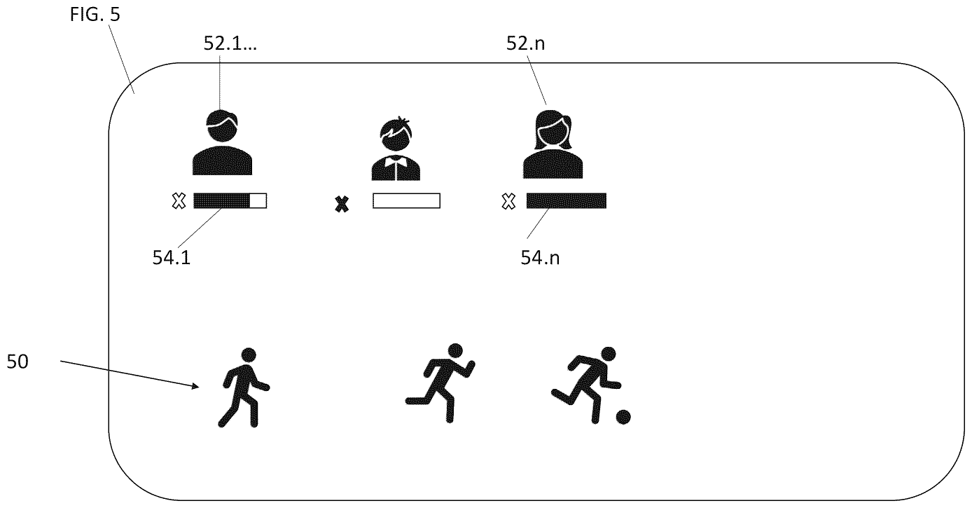

Reference is now made to FIG. 5, which is a simplified diagram showing a user interface for the viewer to operate so as to select and deselect the preferred commentators. The audio-visual apparatus shows a sports event 40. A menu command provides icons for the different voice channels 52.1 . . . 52.n available for the event, which may illustrate the commentators concerned or identify them in any other way. A sound bar 54.1 . . . 54.n is shown underneath, allowing the viewer to set the volume for any of the voice separately. Although a visual interaction is shown, any other suitable kind of interaction may be used, including a voice interaction.

It is stressed that the user interactions are used for any of the present embodiments, including the voiceprint embodiment and the channel identity carrier embodiment and the packet data embodiment to be discussed hereinbelow.

The interface may thus provide a volume control to use to set individual volumes for different voice channels and the volumes set are used for the currently dominant channel.

The broadcaster may be sent feedback from the end user so as to assess which commentators are more and less popular. The feedback may be used to determine compensation, monetary or otherwise, such as accreditation, for the individual commentators.

The interface may be part of an application provided to viewers.

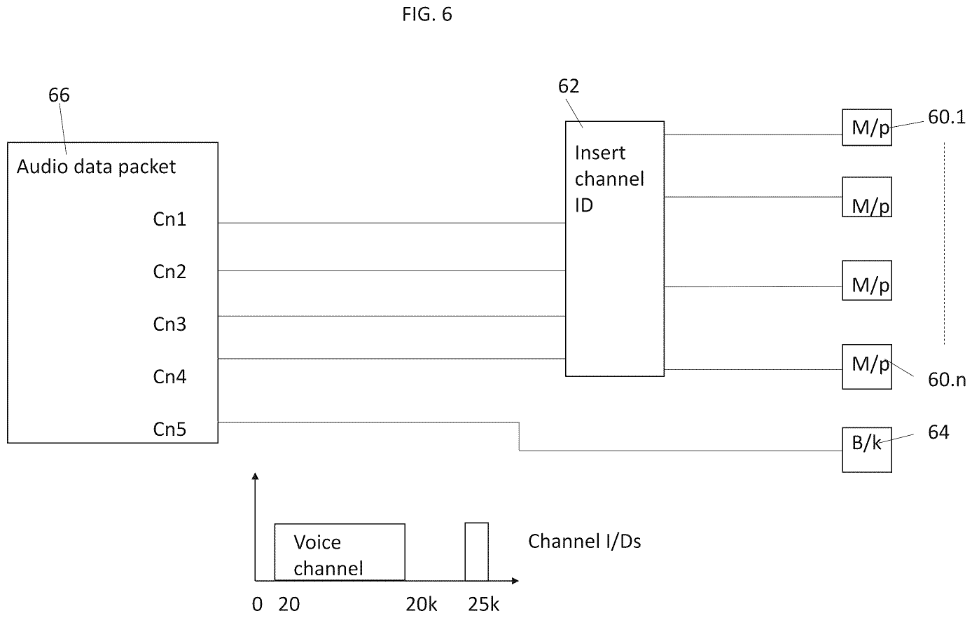

Reference is now made to FIG. 6, which is a simplified block diagram illustrating an embodiment in which the channel sounds are sent in data packets. The channels, received from microphones 60.1 . . . 60.n are sent to box 62 and channel IDs are inserted as before. In a variation each channel is sent in a separate packet if the broadcast format allows it and then the packet header may include the channel identification and it is not necessary to use ultrasonic or digital embedded signals. The background or event sound is here shown as not being given an identification but it may be routed via the channel ID box 62 if desired. If the background channel is suitably identified then it too may be muted if desired. Alternatively, the user may increase the volume of the background channel and reduce the volume for the commentators. The sound data packets are then inserted into the broadcast signal in box 66.

Particularly where packets are used, it is possible to format the broadcast with multiple voice channels, instead of actually mixing. Then each channel may be individually identified and muted or mixed at the receiver end more easily. However this may be only a partial solution as intermediate websites may modify the signal for their own platform so that the original packet assignment may be lost.

In embodiments, a signal may be inserted before and after advertisements are transmitted, and the signal may be used to silence the advertisements. Alternatively, the change in volume often associated with advertising breaks or with any of the individual voice channels in general, may be compensated for.

It is noted that herein the term broadcast refers to any form of sending data where a single source is received at multiple receiving points, typically simultaneously. Such a broadcast may use satellite or terrestrial channels, including radio and microwave links, or cable links, and transmission may be in packets over the Internet or over the cellular network or over WiFi or LAN connections, or combinations thereof. Receiving devices may be televisions, or computers, including desktop and laptop computers, or tablets or mobile telephones, and the embodiments extend to applications for receiving broadcasts in such devices.

In this disclosure, the terms “comprises”, “comprising”, “includes”, “including”, “having” and their conjugates mean “including but not limited to”.

The term “consisting of” means “including and limited to”.

It is appreciated that certain features of the invention, which are, for clarity, described in the context of separate embodiments, may also be provided in combination in a single embodiment and the present description is to be construed as if such embodiments are explicitly set forth herein. Conversely, various features of the invention, which are, for brevity, described in the context of a single embodiment, may also be provided separately or in any suitable subcombination or may be suitable as a modification for any other described embodiment of the invention and the present description is to be construed as if such separate embodiments, subcombinations and modified embodiments are explicitly set forth herein. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

1. Broadcast apparatus for controlling one or more of a plurality of separate sound sources in a broadcast event, the apparatus comprising:
inputs for a plurality of audio channels, each audio channel being related to a one of said separate sound sources;
at least one channel identity inserter for inserting a channel identity signal into at least one of said audio channels, for indicating a respective separate sound source; and
a controller configured to use at least one of said channel identity signals to control audio of said respective audio channel to allow a user to select a desired one of said sound sources.

2. Broadcast apparatus according to claim 1, further comprising a voice mixer, for mixing said plurality of audio channels into a combined audio channel including an indicator of which of said plurality of audio channels is dominant in said combined audio channel.

3. Broadcast apparatus according to claim 1, wherein said at least one channel identity signal and said corresponding indication of relative dominance is ultrasonic or digital.

4. Broadcast apparatus according to claim 1, wherein at least one of said plurality of audio channels carries audio of the event and at least two of said plurality of audio channels comprise voice commentary on said event, said channel identity inserter being configured to insert said channel identity signal for said audio channels comprising voice commentary, or for said background.

5. The broadcast apparatus of claim 1, configured to introduce a delay therein.

6. Receiver apparatus for receiving a broadcast signal having a combined audio channel including a plurality of constituent audio channels, some of said constituent audio channels comprising respective ultrasonic channel identities and the combined audio channel bearing an ultrasonic indicator of a currently dominant audio channel, the receiving apparatus comprising:
an input configured to allow a user to select one or more of said constituent audio channels for muting;
a detector for detecting a currently dominant audio channel in said combined audio channel, and
a volume control for changing a volume or muting at least said currently dominant audio channel in said combined audio channel.

7. Receiver apparatus according to claim 6, wherein said input is configured to allow a volume to be set for at least one of said constituent audio channels; the apparatus further comprising a volume control to use said set volume when said at least one of said constituent audio channels is the dominant audio channel.

8. Receiver apparatus according to claim 7, wherein said muting comprises injecting a 180 degree phase shift of the unwanted channel.

9. Receiver apparatus according to claim 6, configure to introduce a delay.

10. Receiver apparatus according to claim 9, configured to mute predetermined words.

11. Receiver apparatus according to claim 6, configured to counteract changes in volume of said broadcast.

12-16. (canceled)

17. Broadcast method for controlling one or more of a plurality of speakers in a broadcast event, the method comprising:
receiving a plurality of audio channels;
inserting a channel identity signal into at least one of said audio channels;
multiplying respective ones of said at least one channel identity signal with audio of said respective audio channel to provide an indication of relative dominance of said respective audio channel; and
mixing said plurality of audio channels into a combined audio channel including an indicator of which of said plurality of audio channels is dominant in said combined audio channel.

18. Broadcast method according to claim 17, wherein said at least one channel identity signal and said corresponding indication of relative dominance are ultrasonic or digital.

19. Broadcast method according to claim 17, wherein at least one of said plurality of audio channels carries audio of the event and at least two of said plurality of audio channels comprise voice commentary on said event, said inserting of said channel identity signal being carried out for ones of said audio channels comprising voice commentary.

20. Receiver method for receiving a broadcast signal having a combined audio channel including a plurality of constituent audio channels, some of said constituent audio channels comprising respective ultrasonic channel identities and the combined audio channel bearing an ultrasonic indicator of a currently dominant audio channel, the receiving method comprising:
allowing a user to select one or more of said constituent audio channels for controlling;
detecting a currently dominant audio channel in said combined audio channel, and
controlling at least said currently dominant audio channel in said combined audio channel.

21. Receiver method according to claim 20, comprising setting a volume for at least one of said constituent audio channels; the combined channel using said set volume of a respective constituent audio channel which is the dominant audio channel.

22-29. (canceled)
